(19) United States
(12) Patent Application Publication
(10) Pub. No.: US 2007/0296792 A1
(43) Pub. Date: Dec. 27, 2007

(54) Paper shift apparatus and array ink-jet printer having the same and array printer printing method

(75) Inventors: Karp-sik Yun, Hwaseong-si (KR); Jin-ho Park, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 11/604,859

(22) Filed: Nov. 28, 2006

(30) Foreign Application Priority Data
Jun. 21, 2006 (KR) 2006-56103

(51) Int. Cl. B65H 5/00; B41J 2/01

(52) U.S. Cl. 347/104; 271/10.11

(57) ABSTRACT

A paper shift apparatus, an array ink-jet printer having the paper shift apparatus, and an array printer printing method. The array ink-jet printer includes a frame, a print head supported by the frame and including a plurality of nozzles arranged in a width direction of a paper sheet, a feeding roller to rotate in opposite directions to advance and/or retreat the paper sheet toward and/or from the print head and supported by the frame to be shifted toward an axis direction so as to shift the paper sheet toward a direction orthogonal to a direction through which the paper sheet advances, and a feeding roller shifting unit to shift the feeding roller toward the axis direction.

### CROSS-REFERENCE TO RELATED APPLICATIONS

This application claims priority under 35 U.S.C. § 119(a) from Korean Patent Application No. 2006-56103, filed Jun. 21, 2006 in the Korean Intellectual Property Office, the contents of which are incorporated herein by reference in its entirety.

### BACKGROUND OF THE INVENTION

1. Field of the Invention

The present general inventive concept relates to an array ink-jet printer, and more particularly, to a paper shift apparatus to shift a paper sheet toward a main scanning direction, i.e., a direction orthogonal to a feeding direction along which the paper sheet advances, to correct a poor factor, an array ink-jet printer having the same, and an array printer printing method.

2. Description of the Related Art

Array ink-jet printers include a print head having nozzles and having a length corresponding to a width of a paper sheet and adopt a page printing method of continuously spraying inks toward the paper sheet moving in a feeding direction to form an image on the paper sheet. Such an array ink-jet printer can obtain a faster printing speed and a clearer image quality than a line (or shuttle) printing printer and thus has recently become popular.

The array ink-jet printer as described above sprays the inks once through the nozzles formed in a plurality of array heads arranged in a width direction of the paper sheet to form the image. Thus, if the nozzles are blocked or defective, the blocked nozzles do not spray the inks. As a result, band-shaped blanks (poor factors) may appear throughout the paper sheet.

Since a conventional printing method does not correct such poor factors, the poor factors cannot be effectively corrected.

### SUMMARY OF THE INVENTION

The present general inventive concept provides a paper shift apparatus to shift a paper sheet toward a main scanning direction when printing is performed through a repeated shift of the paper sheet, so as to correct a poor factor caused by one or more poor nozzles in an array ink-jet printer.

The present general inventive concept provides an array ink-jet printer having a paper shift apparatus to realize a high resolution image with no poor factor.

The present general inventive concept provides a high resolution printing method of an array ink-jet printer.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing a paper shift apparatus including a feeding roller unit to feed a paper sheet toward a print head in a feeding direction along a paper path and to shift the paper sheet toward an axis direction orthogonal to the feeding direction, and a feeding roller shifting unit to control the feeding roller unit to shift the print paper toward the axis direction.

The feeding roller shifting unit may include a stationary cam member fixed to a frame and including a first cam profile having a plurality of heights from a side toward the other side, a rotary cam member including a second cam profile corresponding to the first cam profile of the stationary cam member to be shifted with respect to the stationary cam member, and comprising a center to which a rotary shaft of the feeding roller unit is connected, and a driving unit to rotate the rotary cam member.

The feeding roller shifting unit may further include an elastic member to maintain an initial position of the feeding roller unit with respect to the frame. The feeding roller may include a gear member combined with the rotary shaft of the feeding roller, and the elastic member may be a coil spring interposed between the gear member and the frame.

The frame, the stationary cam member, and the rotary cam member may respectively include shaft holes through which the rotary shaft of the feeding roller unit penetrates, and the rotary shaft of the feeding roller unit may be connected to the rotary cam member through a stationary ring installed at an end of the rotary shaft protruding through the shaft hole of the rotary cam member.

The first and second profiles may have a rotation symmetry structure.

The first and second profiles may have a step structure.

The driving unit may include a motor as a driving source, a worm installed on a shaft of the driving motor, and a worm wheel installed on the rotary cam member to receive a rotation power from the worm.

The foregoing and/or other aspects of the present general inventive concept may also be achieved by providing an array ink-jet printer including a frame, a print head supported by the frame and including a plurality of nozzles arranged in a width direction of a paper sheet, a feeding roller unit supported by the frame to feed the paper sheet toward the print head in a feeding direction and to shift the print paper in an axis direction to shift the paper sheet toward a direction orthogonal to the feeding direction, and a feeding roller shifting unit to control the feeding roller unit to shift the paper sheet toward the axis direction.

The foregoing and/or other aspects of the present general inventive concept may also be achieved by providing a printing method of an array ink-jet printer including a paper shift apparatus, the method including rotating a feeding roller unit to advance a paper sheet toward a print head in a feeding direction to form a first image, rotating the feeding roller unit to retreat the paper sheet on which the first image has been formed, shifting the feeding roller unit toward an axis direction to shift the retreated paper sheet toward a direction orthogonal to the feeding direction, and rotating the feeding roller unit to advance the shifted paper sheet toward the print head to form a second image on the paper sheet.

The paper sheet may be shifted by a length of a pitch of nozzles of the print head in a right or left direction or may be shifted by ½ of a pitch of nozzles of the print head in the left or right direction.

The foregoing and/or other aspects of the present general inventive concept may also be achieved by providing an image forming apparatus including a feeding roller to rotate to advance a paper sheet toward a print head along a paper path to form a first image, and to rotate to retreat the paper sheet on which the first image has been formed, away from the print head, and a feeding roller shifting unit to shift the feeding roller toward an axis direction to shift the paper sheet, on which the first image has been formed, toward a direction having an angle with to the paper path, wherein the feeding roller rotates to advance the shifted paper sheet toward the print head to form a second image on the shifted paper sheet.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are views illustrating a structure and an operation of a paper shift apparatus usable in an array ink-jet printer according to an embodiment of the present general inventive concept;

FIG. 2 is an exploded perspective view illustrating the paper shift apparatus of FIG. 1;

FIG. 3 is a perspective view illustrating a cam profile of a stationary cam member of the paper shift apparatus of FIG. 1;

FIG. 4 is a schematic view illustrating an array ink-jet printer according to an embodiment of the present general inventive concept; and

FIGS. 5 and 6 are views illustrating a high resolution printing method using an array ink-jet printer according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

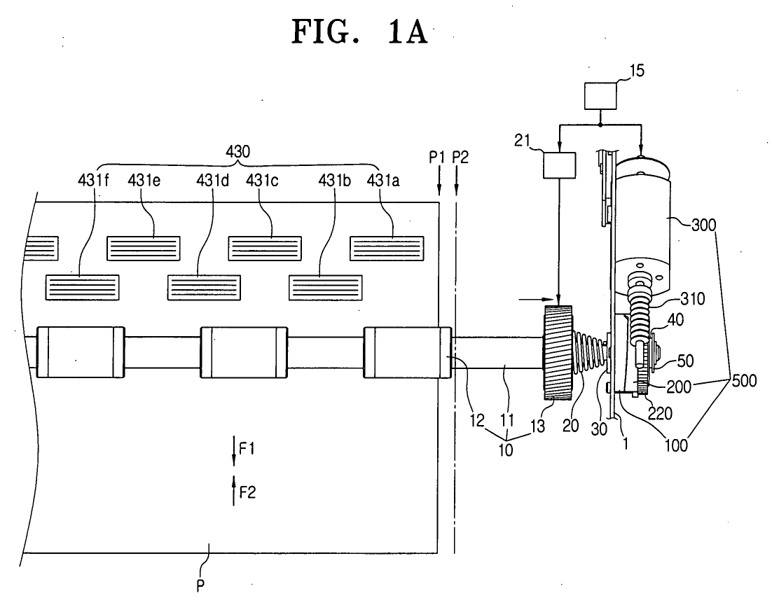

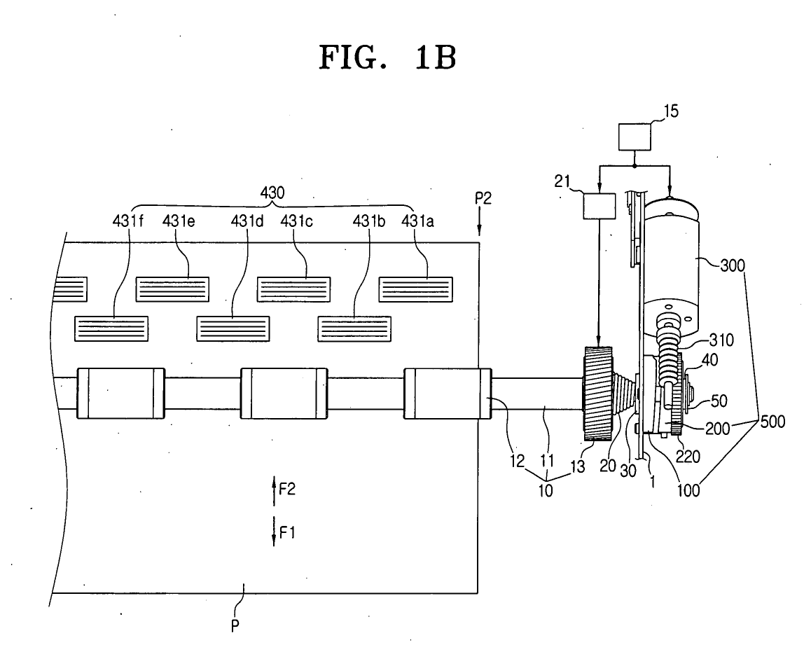

FIGS. 1A and 1B are views illustrating a structure and an operation of a paper shift apparatus usable in an image forming apparatus, such as an array ink-jet printer, according to an embodiment of the present general inventive concept and FIG. 2 is an exploded perspective view illustrating the paper shift apparatus of FIG. 1.

Referring to FIGS. 1A, 1B, and 2, the paper shift apparatus of the array ink-jet printer according to the present embodiment includes a feeding roller unit 10 which shifts a paper sheet and a feeding roller shifting unit 500 which control the feeding roller unit 10 to be shifted toward an axis direction to shift the paper sheet.

The feeding roller unit 10 rotates in clockwise and/or counterclockwise directions to advance (or feed) a paper sheet P toward a print head 430 in a feeding direction F1 and/or retreat (or feed) the paper sheet P from the print head 430 in a retreat direction F2 opposite to the feeding direction. Hereinafter, the feeding direction and the retreat direction are referred to as a feeding direction or sub-scanning direction of the paper sheet P. The feeding roller unit 10 is supported by a frame 1 to be shifted toward the axis direction so as to shift the paper sheet P toward a direction having an angle with the feeding direction, for example, a direction orthogonal to the feeding direction along which the paper sheet P advances, i.e., toward a main scanning direction. That is, the paper sheet P is shifted from a first paper path P1 to a second paper path P2.

The feeding roller unit 10 includes a rotary shaft 11, at least one roller member 12 which is installed on the rotary shaft 11, and a gear member 13 which is installed at an end of the rotary shaft 11 to receive a rotation power from a feeding unit 121 to drive the at least one roller member 12. A controller 15 may control the feeding unit 121 to feed the paper sheet P in opposite direction during a printing operation.

The feeding roller shifting unit 500 includes a stationary cam member 100, a rotary cam member 200, and a driving unit 300 to drive the rotary cam member 200. It is possible that the controller 15 may control the feeding unit 21 and the driving unit 300.

In addition, it is also possible that the feeding unit 21 can be used as the driving unit 300 using a clutch unit or one or more gears to selectively transmit the rotation power of the feeding unit 21 to the rotary cam member 200 since the rotation power can be transmitted to the gear member 13 in a feeding operation to feed the paper sheet P and to the rotary cam member 200 in a shifting operation to shift the paper sheet P.

The paper sheet P can be fed and shifted according to a friction between the paper sheet P and the roller member 12. When each roller member 13 is a pair of rollers disposed opposite sides of the paper sheet P which is disposed on a platen (not illustrated), the pair of rollers can be shifted by the feeding roller unit 10. In this case, one of the pair of the rollers is connected to the gear member 13, and the other one of the pair of the rollers does not receive the rotation power to feed the paper sheet P using a friction with the one of the pair of the rollers, but is shifted together with the one of the pair of the rollers according to the shifting of the feeding roller unit.

The stationary cam member 100 is fixed to the frame 1 and includes a surface on which a first cam profile 110 is formed to be gradually heightened from a side toward the other side. At least one or more combination holes 1a are formed in the frame 1, and one or more combination projections 101 protrude from the stationary cam member 100. Thus, the combination projections 101 are inserted into corresponding ones of the at least one or more combination holes 1a. As a result, the stationary cam member 100 is fixedly combined with the frame 1 so as not to rotate with respect to the frame 1.

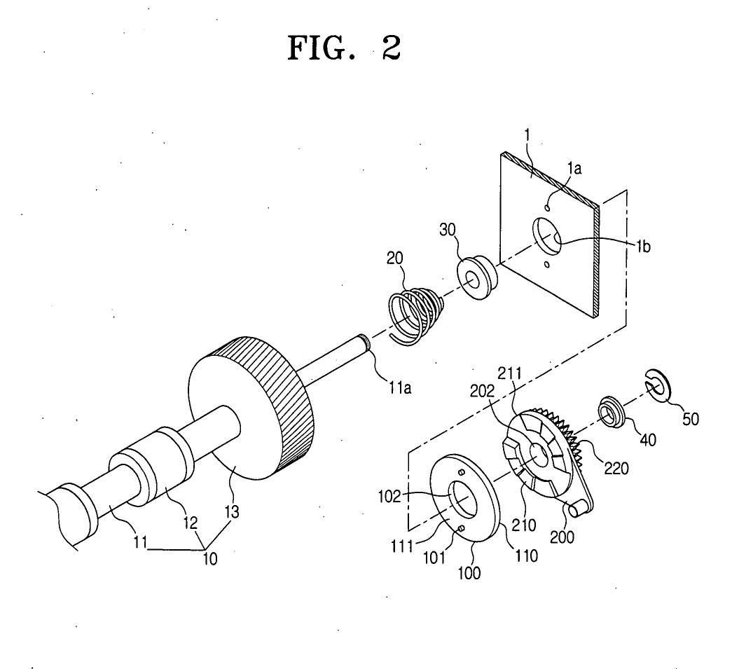

According to the present embodiment, the first cam profile 110 may be formed in a step shape as illustrated in FIGS. 2 and 3.

FIG. 3 is a perspective view illustrating the first cam profile 110 of the stationary cam member 100 according to an embodiment of the present general inventive concept. Referring to FIGS. 1A-3, the first cam profile 110 includes five pairs of steps 110a, 110b, 110c, 110d, and 110e which have different heights and are gradually heightened from the one side (a base 111) to the other side facing the rotary cam member 200.

Each pair of the five pairs of steps has the same height, and the five pairs of steps are classified into first inclined steps 110a having a lowest height through fifth inclined steps 110e having a highest height. The first inclined steps 110a having the same height are disposed at an interval of 1800, and sliding surfaces S are formed between the first inclined steps 110a and the second inclined steps 1106b adjacent to the first inclined steps 110a. The sliding surfaces S are inclined with respect to the base 111 to connect the adjacent steps. The third inclined steps 110c through the fifth inclined steps 110e are constituted in a structure as described above. The first cam profile 110 has a rotation symmetry structure based on the first inclined steps 110a.

The rotary cam member 200 includes a second cam profile 210 corresponding to the first cam profile 110 of the stationary cam member 100 on a side thereof opposite to a second base 211 and is combined with the stationary cam member 100 so as to be separated from the stationary cam member 100. The rotary shaft 11 of the feeding roller unit 10 is combined with a center of the rotary cam member 200. The second cam profile 210 is formed in a shape corresponding to a shape of the first cam profile 110 and thus has a rotation symmetry structure as illustrated in FIG. 2.

Shaft holes 1b, 102, and 202 are formed in the frame 1, the stationary cam member 100, and the rotary cam member 200, respectively. The rotary shaft 11 penetrates the shaft holes 1b, 102, and 202. First and second bushings 30 and 40 are disposed in the shaft hole 1a of the frame 1 and the shaft hole 202 of the rotary cam member 200, respectively, to inhibit a friction between the rotary shaft 11 and the frame 1. A stationary ring 50 is installed at an end 11a of the rotary shaft 11 which protrudes through the shaft hole 202 of the rotary cam member 200, so that the rotary shaft 11 is combined with the rotary cam member 200.

Accordingly, when the rotary cam member 200 receives a power from the driving unit 300 to rotate, the second cam profile 210 slides along the shape of the first cam profile 110 so that the rotary cam member 200 moves with respect to the stationary cam member 100 by a distance. The distance is variable according to contacts between different steps of the stationary cam member 100 and the rotary cam member 200. That is, the rotary cam member 200 moves to shift the roller member 12 of the feeding roller unit 10 so that the paper sheet S is shifted from a first shifted path to a second shifted path in a direction parallel to the axial direction of the roller member 12. Also, the rotary cam member 200 pulls the rotary shaft 11 toward a direction indicated by an arrow illustrated in FIG. 1A to shift the feeding roller 10 toward the axis direction in a direction opposite to the arrow of FIG. 1A, as illustrated in FIG. 1B.

The driving unit 300 rotates the rotary cam member 200. The driving unit 300 includes a motor (not shown), a worm 310 which is installed at the motor, and a power transmitting part 220 which includes a worm wheel formed at an edge of the rotary cam member 200. The driving unit 300 may be a belt-pulley system and rotate the rotary cam member 200 through a gear train (not shown) which supplies a power to the feeding roller 10.

Referring to FIGS. 1A and 1B, an elastic member 20 may be installed between the gear member 13 and the frame 1 so that the rotary member 200 smoothly contacts and/or separates from the stationary cam member 100. If the rotary cam member 200 separates from the stationary cam member 100 as shown in FIG. 1B, the elastic member 20 may be a coil spring so as to shrink. Thus, if the rotary cam member 200 is reversely rotated by the worm 310, the elastic member 20 may return the feeding roller 10 to an initial position as illustrated in FIG. 1A.

In the present embodiment, the elastic member 20 is installed between the gear member 13 and the frame 1 as illustrated in FIGS. 1A and 1B. However, the elastic member 20 may be installed as a tension spring between the stationary cam member 100 and the rotary cam member 200. In other words, if the elastic member 20 keeps the rotary cam member 200 in contact with the stationary cam member 100, any structure may be used as the elastic member 20.

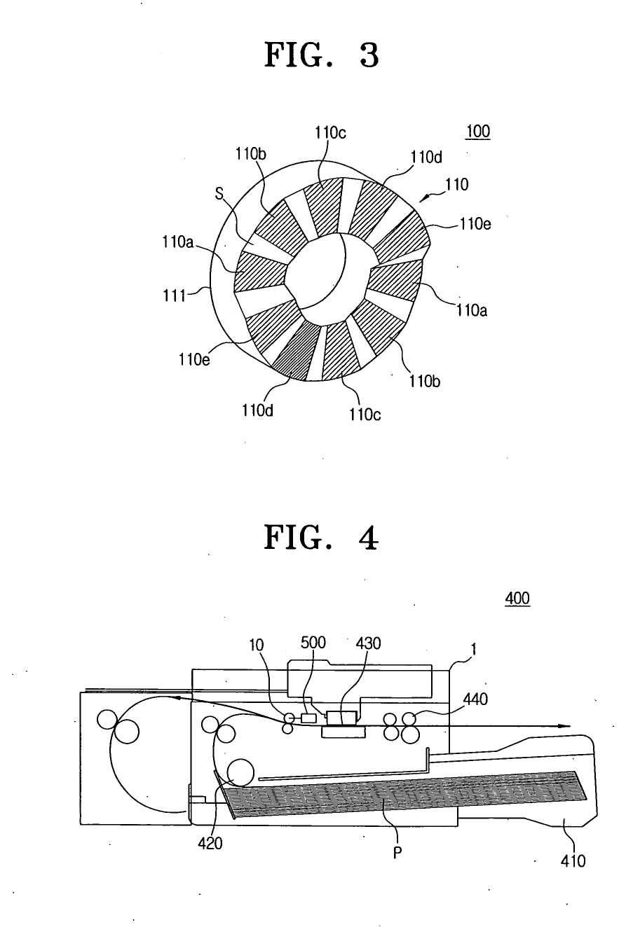

FIG. 4 is a view illustrating an ink-jet printer 400 including a feeding roller shifting unit 500 according to an embodiment of the present general inventive concept. Referring to FIGS. 1A through 4, the ink-jet printer 400 includes a frame 1, a print head 430, a feeding roller 10, and the feeding roller shifting unit 500.

A feeding cassette 410, a pickup unit 420, the feeding roller unit 10, the print head 430, a delivery unit 440, and the feeding roller shifting unit 500 are installed on the frame 1. The feeding cassette 410 contains a plurality of paper sheets P, and the pickup unit 420 picks up the plurality of paper sheets P from the feeding cassette 410 and then feeds the plurality of paper sheets P toward the feeding roller unit 10 along a paper path. The feeding roller unit 10 shifts the plurality of paper sheets P toward the print head 430, and the delivery unit 400 delivers and discharges the plurality of paper sheets P on which images have been formed by the print head 430. The feeding unit 21 of FIGS. 1A and 1B can be used as a driving source to rotate the feeding roller unit of FIG. 4, the pickup unit 420, and/or the delivering unit 440.

The print head 430 includes a plurality of array heads 431a through 431f arrayed at predetermined distances as illustrated in FIGS. 1A and 1B to output one or more line printed images to the plurality of paper sheet P at the same time.

The feeding roller 10 may be shifted by the feeding roller shifting unit 500 toward a direction orthogonal to a direction along which the plurality of paper sheets P advance along the paper path. This is to correct a poor factor (poor performance) of the defective or blocked nozzles using adjacent normal nozzles when a portion of nozzles of the print head 430 do not normally operate. The feeding roller shifting unit 500 shifts the feeding roller 10 in a main scanning direction (perpendicular to the paper path) as described above to shift the paper path from the first shifted path to the second shifted path by several millimeters. The first shifted path may be an original paper path, and the second shifted path may be a path shifted from the first shifted path by a predetermined distance. The first shifted path (first paper path) P1 and the second shifted path (second paper path) P2 are parallel to each other and spaced-apart from each other by the predetermined distance. The predetermined distance may be variable according to contacts between different steps of the stationary cam member 100 and the rotary cam member 200 or the height of the steps of the stationary cam member 100 and the rotary cam member 200.

The feeding roller shifting unit 500 of FIG. 4 has the same structure as the feeding roller shifting unit 500 of FIGS. 1A-3, and thus its description will be omitted.

An operation of an array ink-jet printer having a feeding roller shifting unit according to the present invention will now be described with reference to FIGS. 1A-6.

The feeding roller 10 is in a normal position to feed the paper sheet P along the paper path (for example, the first shifted path) as illustrated in FIG. 1A. When the portion of the nozzles of the print head 430 malfunction, the feeding roller unit 10 is shifted toward the direction indicated by the arrow of FIG. 1A to change a position of the paper sheet P passing the print head 430, for example, from the first shifted path to the second shifted path, as illustrated in FIG. 1B.

The array ink-jet printer 400 includes the plurality of array heads 431a through 431f which are fixedly arrayed to form an image on each of the plurality of paper sheets P passing the print head 430 line by line. However, nozzles of some array heads are blocked and/or defective by reasons that, for example, the nozzles are not used for a long period of time, printed images are not output on portions facing the blocked nozzles. White bands are formed on portions onto which the blocked nozzles (defective nozzles) are to output images. In other words, the factor errors occur.

If such factor errors occur, images to be output by the blocked nozzles may be printed on a paper sheet using normal nozzles to correct the factor errors. For this purpose, the plurality of paper sheets P are shifted toward the normal nozzles along the direction orthogonal to the direction along which the plurality of paper sheets P advance, i.e., along the main scanning direction, so that the normal nozzles are disposed on the position of the paper sheets P advance corresponding to the blocked nozzles to form an image on the position of the paper sheets P. A controller outputs information on the printed images to be output by the blocked nozzles to the normal nozzles in positions to which the plurality of paper sheets P are shifted, so as to output the printed images which are not output by the blocked nozzles.

The above-described operation may be performed through the following process.

The controller rotates the feeding roller unit 10 in a clockwise direction to advance the plurality of paper sheets P toward the print head 430 to form a first image.

However, if a portion of nozzles are blocked or defective and thus normal printing fails, it is determined that the factor errors may occur. In this case, the controller reversely rotates the feeding roller unit 10 to retreat the plurality of paper sheets P on which the first image having the white band, that is, a portion on which ink is not ejected through the blocked nozzles, has been formed.

The controller operates the feeding roller shifting unit 500 to shift a paper path on which the plurality of paper sheets P are retreated toward the direction along which the plurality of paper sheets P advance, i.e., toward the main scanning direction (the direction indicated by the arrow shown in FIG. 1A) by the feeding roller unit 10 and held by the feeding roller unit 10. For this purpose, the controller operates the driving unit 300. In other words, the controller rotates the worm 310 which is connected to a driving motor and a power transmitting part 220 which includes the worm wheel combined with the worm 310, so as to rotate the rotary cam member 200 at a predetermined angle. Thus, the second cam profile 210 of the rotary cam member 200 shifts along the first cam profile 110 of the stationary cam member 100 so as to separate the rotary cam member 200 from the stationary cam member 100 by a distance corresponding to the predetermined angle. As a result, the rotary shaft 11 combined with the rotary cam member 200 shifts toward the direction indicated by the arrow shown in FIG. 1A.

If the controller re-rotates the feeding roller 10 in the clockwise direction to advance the plurality of paper sheets P, which have been shifted, toward the print head 430, the plurality of paper sheets P pass by the print head 430 when being shifted toward the main scanning direction, to form a second image corresponding to a missed image in the first image, that is, in positions in which poor factors occur. Here, the first cam profile 110 includes the first through fifth inclined steps 110a through 110e having the sliding surfaces S. Thus, the plurality of paper sheets P shift toward the main scanning direction by differences among heights of the first through fifth inclined steps 110a through 110e. As a result, the controller transmits information as to images output to be output by the blocked nozzles to the normal nozzles in positions corresponding to distances by which the plurality of paper sheets P shift, so as to output the images which are supposed to be output by the blocked nozzles through the normal nozzles.

Accordingly, a position of the rotary shaft 11 of the feeding roller 10 may vary depending on positions of the blocked nozzles of the array head 430 so that adjacent normal nozzles of the array head 430 output images which are not output by the blocked nozzles of the array head 430.

Also, the feeding roller shifting unit 500 according to the present embodiment may be used to output a high resolution image when nozzles of the array head 430 are not blocked.

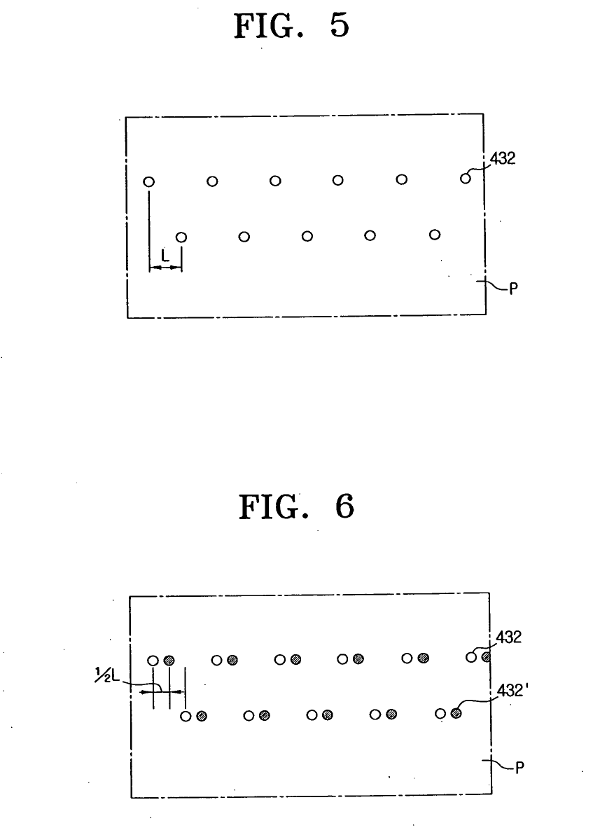

The array ink-jet printer 400 determines a resolution of a printed image depending on a number of nozzles. In other words, if image dots 432 having an interval corresponding to a distance (pitch) between the adjacent nozzles is L are formed as illustrated in FIG. 5, the number of image dots output in a unit area is “11.”

However, if a path through which a paper sheet advances is shifted using the feeding roller shifting unit 500 of the present invention to re-perform printing, additional image dots 432′ may be output in spaces between the image dots 432. For example, if the path through which the plurality of paper sheet is shifted by ½ L as illustrated in FIG. 6, a total number of image dots output in a unit area is increased to “22.” Thus, a resolution of an output image can be improved doubly.

As described above, according to the present general inventive concept, a paper sheet can be repeatedly shifted in an array ink-jet printer to be shifted toward a main scanning direction during printing. Thus, poor factors caused by poor nozzles can be corrected.

Also, the paper sheet can be shifted toward the main scanning direction according to a selection of a user. Thus, a printed image having an improved resolution can be output.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A paper shift apparatus usable in an image forming apparatus, comprising:
a feeding roller unit to feed a paper sheet in a feeding direction along a paper path and to shift the paper sheet in an axis direction orthogonal to the feeding direction; and
a feeding roller shifting unit to control the feeding roller unit to shift the paper sheet in the axis direction.

2. The paper shift apparatus of claim 1, further comprising:
a frame to support the feeding roller unit:
wherein the feeding roller shifting unit comprises:
a stationary cam member fixed to the frame and comprising a first cam profile,
a rotary cam member comprising a second cam profile corresponding to the first cam profile of the stationary cam member to be shifted with respect to the stationary cam member, and comprising a center to which a rotary shaft of the feeding roller is connected, and
a driving unit to rotate the rotary cam member.

3. The paper shift apparatus of claim 2, wherein the feeding roller shifting unit further comprises an elastic member to maintain an initial position of the feeding roller unit.

4. The paper shift apparatus of claim 3, wherein the feeding roller unit comprises a gear member combined with the rotary shaft of the feeding roller unit, and the elastic member is a coil spring interposed between the gear member and the frame.

5. The paper shift apparatus of claim 2, wherein:
the feeding roller unit comprises a rotary shaft;
the frame, the stationary cam member, and the rotary cam member respectively comprise shaft holes through which the rotary shaft of the feeding roller unit penetrates; and
the rotary shaft of the feeding roller unit is connected to the rotary cam member through a stationary ring installed at an end of the rotary shaft protruding through the shaft hole of the rotary cam member.

6. The paper shift apparatus of claim 2, wherein the first and second profiles have rotation symmetry structures.

7. The paper shift apparatus of claim 6, wherein the first and second profiles have step structures.

8. The paper shift apparatus of claim 2, wherein the driving unit comprises:
a driving source;
a worm installed on a shaft of the driving source; and
a worm wheel installed on the rotary cam member to receive a rotation power from the worm.

9. An array ink-jet printer comprising:
a frame;
a print head supported by the frame and comprising a plurality of nozzles arranged in a width direction of a paper sheet;
a feeding roller unit supported by the frame to feed the paper sheet in a feeding direction with respect to the print head, and to shift the paper sheet in an axis direction orthogonal to the feeding direction; and
a feeding roller shifting unit to control the feeding roller to shift the print paper in the axis direction.

10. The array ink-jet printer of claim 9, wherein the feeding roller shifting unit comprises:
a stationary cam member fixed to the frame and comprising a first cam profile;
a rotary cam member comprising a second cam profile corresponding to the first cam profile of the stationary cam member to be shifted with respect to the stationary cam member, and comprising a center to which a rotary shaft of the feeding roller is connected;
a driving unit to rotate the rotary cam member.

11. The array ink-jet printer of claim 10, wherein the feeding roller shifting unit further comprises an elastic member to maintain an initial position of the feeding roller unit.

12. The array ink-jet printer of claim 11, wherein the feeding roller comprises a gear member combined with the rotary shaft of the feeding roller unit, and the elastic member is a coil spring interposed between the gear member and the frame.

13. The array ink-jet printer of claim 10, wherein:
the feeding roller unit comprises a rotary shaft;
the frame, the stationary cam member, and the rotary cam member respectively comprise shaft holes through which the rotary shaft of the feeding roller unit penetrates; and
the rotary shaft of the feeding roller is connected to the rotary cam member through a stationary ring installed at an end of the rotary shaft protruding through the shaft hole of the rotary cam member.

14. The array ink-jet printer of claim 10, wherein the first and second profiles have rotation symmetry structures.

15. The array ink-jet printer of claim 14, wherein the first and second profiles have step structures.

16. The array ink-jet printer of claim 10, wherein the driving unit comprises:
a motor as a driving source;
a worm installed on a shaft of the driving motor; and
a worm wheel installed on the rotary cam member to receive a rotation power from the worm.

17. A printing method of an array ink-jet printer comprising a paper shift apparatus, comprising:
rotating a feeding roller to advance a paper sheet toward a print head along a paper path to form a first image;
rotating the feeding roller to retreat the paper sheet on which the first image has been formed, along the paper path;
shifting the feeding roller toward an axis direction to shift the retreated paper sheet toward a direction orthogonal to the paper path; and
rotating the feeding roller to advance the shifted paper sheet toward the print head to form a second image on the shifted paper sheet.

18. The printing method of claim 17, wherein the shifting of the feeding roller comprises shifting the paper sheet by a pitch of nozzles of the print head in the axial direction.

19. The printing method of claim 17, wherein the shifting of the feeding roller comprises shifting the paper sheet by ½ of a pitch of nozzles of the print head in the axial direction.

20. An image forming apparatus comprising, comprising:
a feeding roller to rotate to advance a paper sheet toward a print head along a paper path to form a first image, and to rotate to retreat the paper sheet on which the first image has been formed, away from the print head; and
a feeding roller shifting unit to shift the feeding roller toward an axis direction to shift the paper sheet, on which the first image has been formed, toward a direction having an angle with to the paper path,
wherein the feeding roller rotates to advance the shifted paper sheet toward the print head to form a second image on the shifted paper sheet.

21. The array ink-jet printer of claim 20, wherein the paper path comprises a first paper path and a second paper path spaced-apart from the first paper path by a distance, and the feeding roller shifting unit controls the feeding roller to shift the print paper from the first paper path to the second paper path.

22. The array ink-jet printer of claim 21, wherein the first paper path and the second paper path are parallel to each other.

23. The array ink-jet printer of claim 21, wherein the feeding roller shifting unit shifts the feeding roller toward the axis direction to shift the retreated paper sheet in the direction.

24. The array ink-jet printer of claim 21, wherein the direction is parallel to the axial direction.

25. The array ink-jet printer of claim 20, further comprising:
a driving unit to control the feeding roller to feed the print paper in a paper feeding direction and the paper roller sifting unit to shift the print paper in the axial direction.

26. The array ink-jet printer of claim 20, wherein the feeding roller shifting unit comprises a rotary cam member having a profile to control the feeding roller to shift the print paper from the paper path to another paper path.

27. The array ink-jet printer of claim 20, wherein the feeding roller shifting unit comprises a rotary cam member to move the feeding roller by a distance such that the print head forms the second image spaced-apart from the first image by the distance.
